(19) United States
(12) Patent Application Publication
(10) Pub. No.: US 2020/0298434 A1
(43) Pub. Date: Sep. 24, 2020

(54) CUTTING DEVICE

(71) Applicants: HONGFUJIN PRECISION ELECTRONICS (ZHENGZHOU) CO., LTD., Zhengzhou (CN); HON HAI PRECISION INDUSTRY CO., LTD., New Taipei (TW)

(72) Inventors: XI-HANG LI, Zhengzhou (CN); JUN-KANG FANG, Zhengzhou (CN); WEI WU, Zhengzhou (CN); GUO-FU ZHANG, Zhengzhou (CN); EN-SONG XIE, Zhengzhou (CN); ZHEN-KE ZHANG, Zhengzhou (CN); QING-LEI PAN, Zhengzhou (CN)

(21) Appl. No.: 16/564,161

(22) Filed: Sep. 9, 2019

(30) Foreign Application Priority Data
Mar. 18, 2019 (CN) 201920338925.5

(51) Int. Cl. B26D 7/02; B26D 7/00

(52) U.S. Cl. CPC B26D 7/025; B26D 7/015; B26D 7/0006

(57) ABSTRACT

A cutting device configured to cut a workpiece includes a base and a cover plate. The cover plate includes a base plate, a pressing member, and an elastic member. A surface of the base plate facing the base defines a receiving groove configured to receive the pressing member. The pressing member defines a number of first cutter slots to allow cutters to pass through to cut the workpiece located between the base and the cover plate. The elastic member includes a connecting portion and an elastic portion. The connecting portion is fixedly coupled to the pressing member and partially extends beyond an edge of the pressing portion. One end of the elastic portion abuts against the base plate, and a second end of the elastic portion is coupled to the connecting portion.

### FIELD

The subject matter herein generally relates to cutting devices, and more particularly to a cutting device for cutting a workpiece.

### BACKGROUND

A printed circuit board (PCB) is generally divided into a plurality of sub-boards after printing by a cutting device. Cutting devices in the related art includes a base for supporting and positioning the PCB, and a cover plate for pressing the PCB. However, after the PCB is cut, the cover plate may adhere to pieces of the PCB which adversely affects the process.

### BRIEF DESCRIPTION OF THE DRAWINGS

Implementations of the present disclosure will now be described, by way of embodiments, with reference to the attached figures.

FIG. 1 is an assembled, isometric view of an embodiment of a cutting device.

FIG. 2 is an exploded, isometric view of the cutting device in FIG. 1.

FIG. 3 is an isometric view of a cover plate of the cutting device showing a close-up view of an elastic member of the cover plate.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

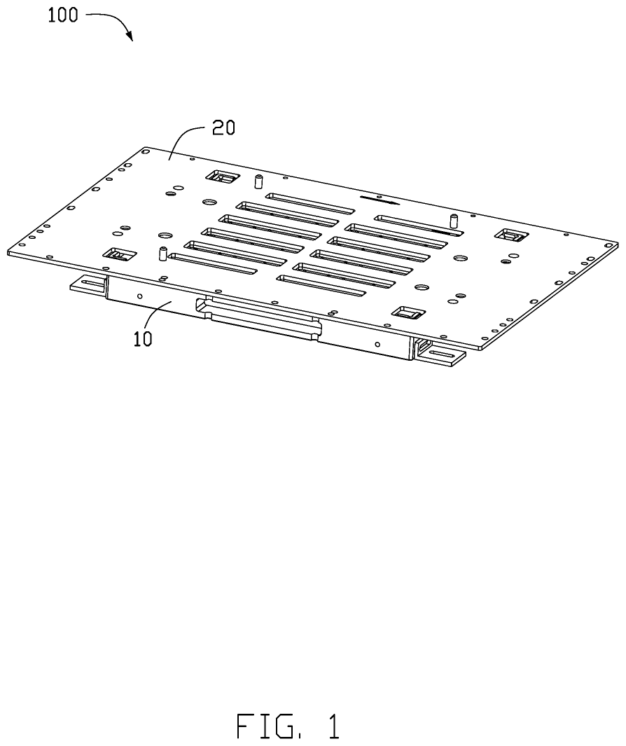

FIG. 1 shows an embodiment of a cutting device 100 for dividing a workpiece (not shown). The cutting device 100 includes a base 10 and a cover plate 20. The cover plate 20 is configured to press a workpiece placed on the base 10.

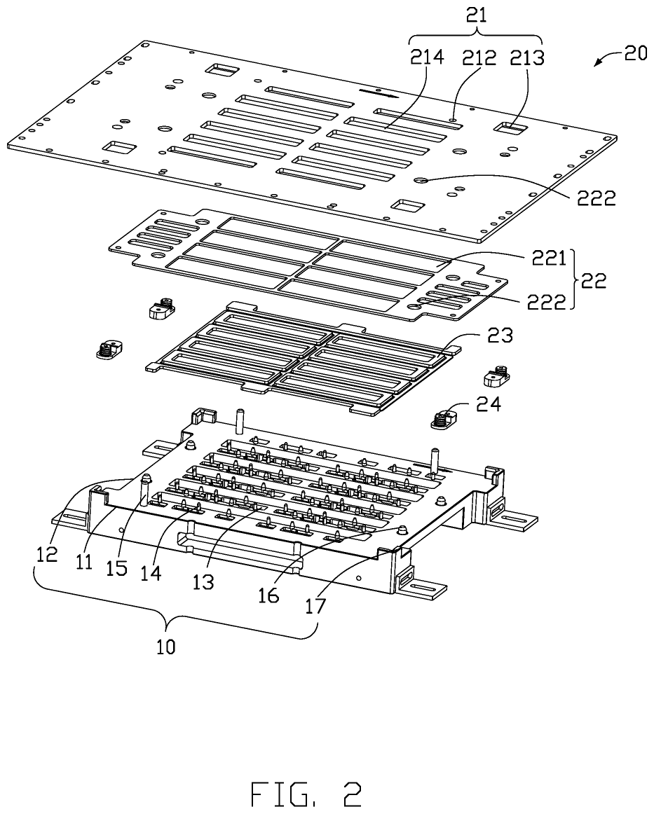

Referring to FIG. 2, the cover plate 20 includes a base plate 21 and a pressing member 22. The pressing member 22 is mounted on the base plate 21, and the pressing member 22 and the base plate 21 cooperatively press the workpiece placed on the base 10. A plurality of first cutter slots 221 are defined in the pressing member 22 to allow cutters to pass through to cut the workpiece.

The base 10 is substantially rectangular in cross-section and includes two oppositely disposed long sides 11, two oppositely disposed short sides 12, a plurality of second cutter slots 13, a plurality of positioning pins 14, a plurality of first positioning members 15, a plurality of second positioning members 16, and a plurality of guiding seats 17. The two long sides 11 and the two short sides 12 are arranged in a rectangular shape. Each second cutter slot 13 is substantially rectangular. A long side of each second cutter slot 13 is parallel to the long sides 11, and a short side of each second cutter slot 13 is parallel to the short sides 12. The second cutter slots 13 are spaced apart in a direction parallel to the short sides 12. The positioning pins 14 are disposed between every two adjacent second cutter slots 13 and between the long sides 11 and the adjacent second cutter slot 13. Each first positioning member 15 is substantially cylindrical, and the first positioning members 15 are disposed on opposite sides of the base 10 between the long sides 11 and the long side of the second cutter slots 13. Each second positioning member 16 is substantially cylindrical, and the second positioning members 16 are disposed on opposite sides of the base 10 between the short sides 12 and the short side of the second cutter slots 13. Each guide seat 17 is substantially L-shaped and disposed at a corresponding corner of the base 10.

In one embodiment, a quantity of the first positioning members 15 is three, such that two first positioning members 15 are disposed on one side of the base 10, and one first positioning member 15 is disposed on the other side of the base 10. A quantity of the second positioning members 16 is four, such that two second positioning members 16 are disposed on each of opposite sides of the base 10. A quantity of the guide seats 17 is four, such that the four guide seats 17 are respectively disposed at four corners of the base 10.

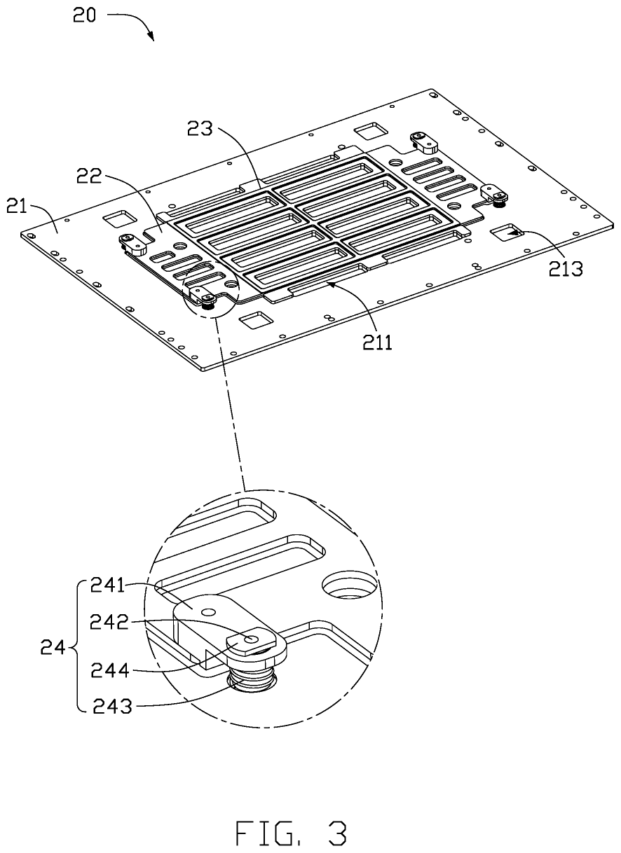

Referring to FIGS. 2-3, the cover plate 20 further includes a foam member 23 and an elastic member 24. The base plate 21 is substantially a rectangular plate. A side of the base plate 21 defines a receiving groove 211 for receiving the pressing member 22. The base plate 21 defines a plurality of first positioning holes 212, and the plurality of positioning members 15 are respectively received in the first positioning holes 212. The base plate 21 further defines a plurality of guiding holes 213, and the plurality of guiding seats 17 are respectively received in the guiding holes 213. The pressing member 22 is substantially a rectangular plate having a notch defined in each corner. A plurality of third cutter slots 214 are defined in the base plate 21, and the first cutter slots 221, the second cutter slots 13, and the third cutter slots 214 are configured to align with each other to allow the cutters to pass through to cut the workpiece. A plurality of second positioning holes 222 are defined in the base plate 21 and the pressing member 22, and the second positioning members 16 are respectively received through a pair of second positioning holes 222 defined in the base plate 21 and the pressing member 22. The foam member 23 has an outline shape matching a shape of the pressing member 22 and is disposed on a side of the pressing member 22 facing the base 10 to prevent the pressing member 22 from directly contacting the workpiece to prevent the pressing member 22 from damaging the workpiece.

The elastic member 24 includes a connecting portion 241, a main body 242, an elastic portion 243, and a stopping portion 244. The connecting portion 241 is substantially plate-shaped and is coupled to a side of the pressing member 22 opposite to the base plate 21 and adjacent to the notch of the corner of the pressing member 22. The main body 242 is substantially cylindrical. One end of the main body 242 is fixedly coupled to a side of the base plate 21, and a second end of the main body 242 extends through the connecting portion 241. The elastic portion 243 is sleeved over the main body 242. One end of the elastic portion 243 abuts against the base plate 21, and a second end of the elastic portion 243 abuts against the stopping portion 244. The stopping portion 244 is substantially plate-shaped and is fixedly coupled to a side of the connecting portion 241 facing away from the base plate 21. In one embodiment, the elastic portion 243 is a spring.

Compared with the related art, when the pressing member 22 presses the workpiece with the base plate 21, the pressing member 22 is received in the receiving groove 211, and the elastic members 24 are in a compressed state. In the compressed state, two ends of the elastic member 24 respectively abut the base plate 21 and the stopping portion 244. Because the pressing member 22 defines the plurality of first cutter slots 221, a contact area between the pressing member 22 and pieces of the workpiece after being divided is minimized, so that the pieces of the workpiece may not stick to the pressing member 22 and be lifted off the base plate 21 when the cover plate 20 is removed easily. When the cover plate 20 is removed, the elastic members 24 are decompressed by the base plate 21 being moved away from the base 10, and then the pressing member 22 is moved away from the base 10 after the elastic members 24 are fully decompressed to delay separation of the pressing member 22 from the workpiece.

It can be understood that in other embodiments, the first positioning members 15 can be omitted.

It can be understood that in other embodiments, the main body 242 and the stopping portion 244 of the elastic members 24 can be omitted.

It can be understood that in other embodiments, the elastic portion 243 can be a columnar structure having compression and elasticity characteristics.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A cutting device configured to cut a workpiece, the cutting device comprising:
a base; and
a cover plate; wherein:
the cover plate comprises a base plate, a pressing member, and an elastic member;
a surface of the base plate facing the base defines a receiving groove configured to receive the pressing member;
the pressing member defines a plurality of first cutter slots configured for cutters to pass through to cut the workpiece placed between the base and the cover plate;
the elastic member comprises a connecting portion and an elastic portion;
the connecting portion is fixedly coupled to the pressing member and partially extends beyond an edge of the pressing member;
one end of the elastic portion abuts against the base plate, and a second end of the elastic portion is coupled to the connecting portion.

2. The cutting device of claim 1, wherein:
the base defines a plurality of second cutter slots;
the base plate defines a plurality of third cutter slots;
each of the plurality of second cutter slots and the plurality of third cutter slots is respectively aligned with a corresponding one of the plurality of first cutter slots thereby the cutters may cut the workpiece.

3. The cutting device of claim 1, wherein:
the base comprises a plurality of first positioning members on a side of the base facing the base plate; and
the base plate defines a plurality of first positioning holes configured to respectively receive the plurality of first positioning members.

4. The cutting device of claim 1, wherein:
the base comprises a plurality of second positioning members on the side of the base facing the base plate; and
the base plate defines a plurality of second positioning holes configured to respectively receive the plurality of second positioning members.

5. The cutting device of claim 1, wherein:
the base comprises a plurality of positioning pins configured to position the workpiece on the base between the base and the cover plate.

6. The cutting device of claim 1, wherein:
the cover plate comprises a foam member disposed on a side of the pressing member facing the base.

7. The cutting device of claim 1, wherein:
the elastic member further comprises a main body;
one end of the main body is fixedly coupled to the base plate, and a second end of the main body passes through the connecting portion;
the elastic portion is sleeved over the main body.

8. The cutting device of claim 7, wherein:
the elastic member further comprises a stopping portion; and
the stopping portion is coupled to a side of the connecting portion facing away from the base plate to fixedly couple the second end of the elastic portion to the connecting portion.

9. The cutting device of claim 1, wherein:
the elastic portion is a spring.

10. A cutting device configured to cut a workpiece, the cutting device comprising:
a base; and
a cover plate; wherein:
the cover plate comprises a base plate and a pressing member;
a surface of the base plate facing the base defines a receiving groove configured to receive the pressing member when the workpiece is pressed by the pressing member;
the pressing member defines a plurality of first cutter slots configured for cutters to pass through to cut the workpiece placed between the base and the cover plate;
the base defines a plurality of second cutter slots respectively aligned with the plurality of first cutter slots thereby the cutters may cut the workpiece;
the base comprises two oppositely disposed long sides and two oppositely disposed short sides;
the plurality of second cutter slots are arranged parallel to each other and extend parallel to the long sides;
the plurality of second cutter slots are spaced apart in a direction parallel to the short sides.

11. The cutting device of claim 10, wherein:
the cover plate further comprises an elastic member;
the elastic member comprises a connecting portion and an elastic portion;
the connecting portion is fixedly coupled to the pressing member and partially extends beyond an edge of the pressing member;
one end of the elastic portion abuts against the base plate, and a second end of the elastic portion is coupled to the connecting portion.

12. The cutting device of claim 11, wherein:
the base defines a plurality of second cutter slots;
the base plate defines a plurality of third cutter slots;
each of the plurality of second cutter slots and the plurality of third cutter slots is respectively aligned with a corresponding one of the plurality of first cutter slots thereby the cutters may cut the workpiece.

13. The cutting device of claim 12, wherein:
the base comprises a plurality of first positioning members on a side of the base facing the base plate; and
the base plate defines a plurality of first positioning holes configured to respectively receive the plurality of first positioning members.

14. The cutting device of claim 13, wherein:
the base comprises a plurality of second positioning members on the side of the base facing the base plate; and
the base plate defines a plurality of second positioning holes configured to respectively receive the plurality of second positioning members.

15. The cutting device of claim 14, wherein:
the base comprises a plurality of positioning pins configured to position the workpiece on the base between the base and the cover plate.

16. The cutting device of claim 15, wherein:
the cover plate comprises a foam member disposed on a side of the pressing member facing the base.

17. The cutting device of claim 16, wherein:
the elastic member further comprises a main body;
one end of the main body is fixedly coupled to the base plate, and a second end of the main body passes through the connecting portion;
the elastic portion is sleeved over the main body.

18. The cutting device of claim 17, wherein:
the elastic member further comprises a stopping portion; and
the stopping portion is coupled to a side of the connecting portion facing away from the base plate to fixedly couple the second end of the elastic portion to the connecting portion.

19. The cutting device of claim 11, wherein:
the elastic portion is a spring.
